(19) United States
(12) Patent Application Publication
(10) Pub. No.: US 2026/0292715 A1
(43) Pub. Date: Sep. 24, 2026

(54) RADIO FREQUENCY EXPOSURE COMPLIANCE FOR EMERGENCY COMMUNICATIONS

(71) Applicant: QUALCOMM Incorporated, San Diego, CA (US)

(72) Inventors: Rajeev Kumar SINGH, Hyderabad (IN); Imran ANSARI, Hyderabad (IN)

(21) Appl. No.: 19/088,425

(22) Filed: Mar. 24, 2025

(51) Int. Cl. H04W 52/36; H04B 1/3827; H04W 52/26; H04W 76/50

(52) U.S. Cl. CPC H04W 52/367; H04B 1/3838; H04W 52/262; H04W 76/50

(57) ABSTRACT

Certain aspects of the present disclosure provide techniques and apparatus for optimizing (or at least improving) communication performance of a wireless device during an emergency session while ensuring radio frequency (RF) exposure compliance. An example method of wireless communication includes determining a transmit power budget for a time window comprising an emergency session for the wireless device, based on an RF exposure limit. An amount of the transmit power budget to reserve for the emergency session for the wireless device is determined. Communications are performed during the emergency session based on the amount of the transmit power budget.

### BACKGROUND

### Field of the Disclosure

Aspects of the present disclosure relate to wireless communications, and more particularly, to optimizing (or at least improving) communication performance of a wireless device during emergency communications while ensuring radio frequency (RF) exposure compliance.

### Description of Related Art

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include improving performance of emergency communications in compliance with a radio frequency (RF) limit.

Certain aspects of the subject matter described in this disclosure can be implemented in a method for wireless communication by a wireless device. The method generally includes determining a transmit power budget for a time window comprising an emergency session for the wireless device, based on a radio frequency (RF) exposure limit. The method also includes determining an amount of the transmit power budget to reserve for the emergency session for the wireless device. The method also includes reserving the amount of the transmit power budget for the emergency session. The method further includes performing communications during the emergency session based on the amount of the transmit power budget.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to: determine a transmit power budget for a time window comprising an emergency session for the apparatus, based on a radio frequency (RF) exposure limit; determine an amount of the transmit power budget to reserve for the emergency session for the apparatus; reserve the amount of the transmit power budget for the emergency session; and perform communications during the emergency session based on the amount of the transmit power budget.

Certain aspects of the subject matter described in this disclosure can be implemented in an apparatus for wireless communication. The apparatus generally includes means for determining a transmit power budget for a time window comprising an emergency session for the apparatus, based on a radio frequency (RF) exposure limit. The apparatus also includes means for determining an amount of the transmit power budget to reserve for the emergency session for the apparatus. The apparatus also includes means for reserving the amount of the transmit power budget for the emergency session. The apparatus further includes means for performing communications during the emergency session based on the amount of the transmit power budget.

Certain aspects of the subject matter described in this disclosure can be implemented in a computer-readable medium. The computer-readable medium has instructions stored thereon for performing an operation. The operation includes determining a transmit power budget for a time window comprising an emergency session for a wireless device, based on a radio frequency (RF) exposure limit. The operation also includes determining an amount of the transmit power budget to reserve for the emergency session for the wireless device. The operation also includes reserving the amount of the transmit power budget for the emergency session. The operation further includes performing communications during the emergency session based on the amount of the transmit power budget.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a graph illustrating examples of transmit powers over time in compliance with an RF exposure limit, in accordance with certain aspects of the present disclosure.

FIG. 4A is a diagram illustrating an example wireless device having multiple radios, in accordance with certain aspects of the present disclosure.

FIG. 4B is a diagram illustrating an example logical architecture for controlling the RF exposure associated with one or more radios, in accordance with certain aspects of the present disclosure.

FIG. 5 depicts an example call flow for establishing an emergency session between an access point (AP) and a wireless stations (STA), in accordance with certain aspects of the present disclosure.

FIG. 6A depicts an example allocation of transmit power over time.

FIG. 6B depicts an example allocation of transmit power over time with a transmit power reservation for an emergency session, in accordance with certain aspects of the present disclosure.

FIG. 7 is a flow diagram illustrating example operations for wireless communication by a wireless device, in accordance with certain aspects of the present disclosure.

FIG. 8 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for optimizing (or at least improving) communication performance of a wireless device during an emergency session (also referred to as an emergency communication session) in compliance with a radio frequency (RF) exposure limit.

During an emergency, public communication networks can become overloaded/overwhelmed, limiting the ability of such networks to facilitate communications for emergency service(ES) or emergency 911 (E911) personnel and/or public users. Such emergencies can include natural disasters (e.g., hurricanes, tornadoes, earthquakes, floods, wildfires, blizzards, snowstorms, tsunamis, and volcanic eruptions, among others), weather emergencies (e.g., extreme heat, droughts, high winds, and winter storms, among others), biological emergencies (e.g., diseases, pandemics, etc.), chemical emergencies (e.g., harmful chemical spills), and radiological emergencies (e.g., release of harmful radiation), as illustrative examples. As such, certain wireless communications systems (e.g., Institute of Electrical and Electronics Engineers (IEEE) 802.11be, also known as Wi-Fi 7, and later versions) support emergency preparedness communication services (EPCS), which provides preferred or prioritized channel access over public/private wireless networks (e.g., Wi-Fi networks) in emergencies. For example, with EPCS, wireless devices can gain priority access to the wireless medium with prioritized channel access parameters (e.g., dedicated enhanced distributed channel access (EDCA) parameters) for transmission of emergency traffic (e.g., data). Compared to channel access parameters used for transmission of non-emergency traffic (e.g., non-EPCS traffic), such prioritized channel access parameters may include a smaller minimum contention window (CWmin), a smaller maximum contention window (CWmax), a lower arbitration interframe space number (AIFSN), and a higher transmission opportunity (TXOP) limit, as illustrative examples. EPCS can provide a seamless service experience to users while maintaining the priority and quality of service (QoS) in wireless access networks for communication of emergency traffic.

Additionally, in certain cases, a wireless device may manage radio frequency (RF) exposure of one or more radios for one or more radio access technologies (RATs) in compliance with an RF exposure limit. A wireless device may be capable of communicating via multiple RATs, such as wireless wide area network (WWAN) RAT(s) (e.g., 5G New Radio (NR), Evolved Universal Terrestrial Radio Access (E-UTRA), Universal Mobile Telecommunications System (UMTS) and/or code division multiple access (CDMA)), wireless local area network (WLAN) RATs (e.g., IEEE 802.11), short-range communications (e.g., Bluetooth), non-terrestrial network (NTN) communications, device-to-device (D2D) communications, vehicle-to-everything (V2X) communications, and/or other communications (e.g., future RAT(s)). In certain cases, the wireless device may control the transmission power level(s) of the radio(s) using various techniques described herein in order to maintain RF compliance across the radios.

The wireless device may manage RF exposure of a radio(s) of the wireless device for a (running) time window (e.g., 4 seconds for millimeter wave (mmWave), 2 seconds for 60 gigahertz (GHz) bands, 100 or 360 seconds for bands less than or equal to 6 GHz, etc.) in compliance with an RF exposure limit. The wireless device may perform an RF exposure assessment of past RF exposure over a given time window to determine a maximum allowable transmit power for a future time interval in the time window. The wireless device may provide a respective transmit power limit (or allocation or budget) to each of the radios that applies for a specific time interval of the (running) time window, in compliance with the RF exposure limit. In some cases, compliance with the RF exposure limit may be performed as a time-averaged RF exposure evaluation within a specified running (moving) time window associated with the RF exposure limit.

In some cases, the wireless device may allocate transmit power to radios in compliance with an RF exposure limit (e.g., time-averaged RF exposure limit) in a manner that impacts the communication performance of the wireless device during an emergency session (e.g., EPCS session). For example, a time-averaged RF exposure evaluation may allow the wireless device to output relatively high-power transmission burst(s) in compliance with the time-averaged RF exposure limit. In some cases, however, a high-power transmission burst may use most or all of the RF exposure margin (or RF exposure budget) associated with the time-averaged RF exposure limit in a short duration relative to the time window. In cases where the high-power transmission burst occurs during a non-emergency session, after the high-power transmission burst, the wireless device may maintain the transmit power at a reserve level (e.g., lower transmit power level) during an emergency session or may refrain from transmitting during the emergency session for the remainder of the time window to ensure compliance with the time-averaged RF exposure limit. In such cases, the communication performance of the wireless device during the emergency session for transmission of emergency communications (e.g., high-priority, latency-sensitive data) may be impacted in terms of lower throughput, lower transmit power, increased latency, high number of re-transmissions, and/or lower transmission range, as illustrative, non-limiting examples.

Aspects of the present disclosure provide apparatus and methods for optimizing (or at least improving) the communication performance of a wireless device during an emergency session in compliance with an RF exposure limit. In certain aspects, the wireless device may reserve a certain amount of a transmit power budget (e.g., transmit power resources) for a wireless device to use during an emergency session (e.g., EPCS session). The transmit power budget may be applicable to a (running) time window that includes the emergency session or a portion thereof and may be determined in compliance with an RF exposure limit (e.g., time-averaged RF exposure limit). In some cases, the reservation of the amount of the transmit power budget may occur when the emergency session has been established for the wireless device.

The wireless device may perform communications during the emergency session, based on the amount of the transmit power budget reserved for the emergency session. The communications may include emergency communications (for traffic, such as data), such as alerts and warnings, directives about evacuation, curfews, and/or other self-protective actions, and information about response status, family members, and available assistance, as illustrative examples. The emergency communications may include any one of (or combination of) various data types, such as voice data (e.g., voice (SOS) calls over wireless networks, also known as voice over Wi-Fi (VoWiFi)), video data (e.g., streaming video content), file transfer data, and sensor data (e.g., data collected from wireless sensors in Internet of Things (IoT) applications), as illustrative examples.

In certain aspects, the wireless device may determine the particular amount of the transmit power budget to reserve for the emergency session based on one or more parameters. Such parameter(s) may include a type of expected emergency communication (or traffic or data) to be exchanged during the emergency session, a highest sustainable transmit power parameter associated with a modulation and coding scheme (MCS) rate used prior to the emergency session (e.g., rate-to-power (R2P) parameter), one or more weight parameters, or any combination thereof.

Additionally or alternatively, in certain aspects, the wireless device may disable one or more transmit power restrictions for the wireless device for a duration of the emergency session, e.g., after determining that the emergency session has been established for the wireless device. In such aspects, the wireless device may determine the particular amount of the transmit power budget to reserve for the emergency session after the one or more transmit power restrictions have been disabled.

The apparatus and methods for optimizing (or at least improving) communication performance of the wireless device during an emergency session in compliance with an RF exposure limit may provide various technical advantages. For example, reserving a certain amount of transmit power resources for the emergency session using the techniques described herein may allow the wireless device to improve wireless communication performance (e.g., increased throughput, decreased latency, increased transmission range, and/or lower number of retransmissions of data) during the emergency session for transmission of emergency communications (e.g., high-priority, latency-sensitive data).

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., WWAN, WLAN, short-range communications (e.g., Bluetooth), NTN communications, D2D communications, V2X communications, etc.) used for wireless communications. For example, for uplink carrier aggregation (or multi-connectivity) in WWAN, each of the active component carriers used for wireless communications may be treated as a separate radio. Similarly, multi-band transmissions for IEEE 802.11 may be treated as separate radios for each frequency band (e.g., 2.4 gigahertz (GHz), 5 GHz, and/or 6 GHz). In some examples, a radio is defined based on a RAT and/or frequency for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G NR) wireless technologies, aspects of the present disclosure can be applied in other generation-based communication systems and/or to wireless technologies such as IEEE 802.11, 802.15, etc.

### Example Wireless Communication Network and Devices

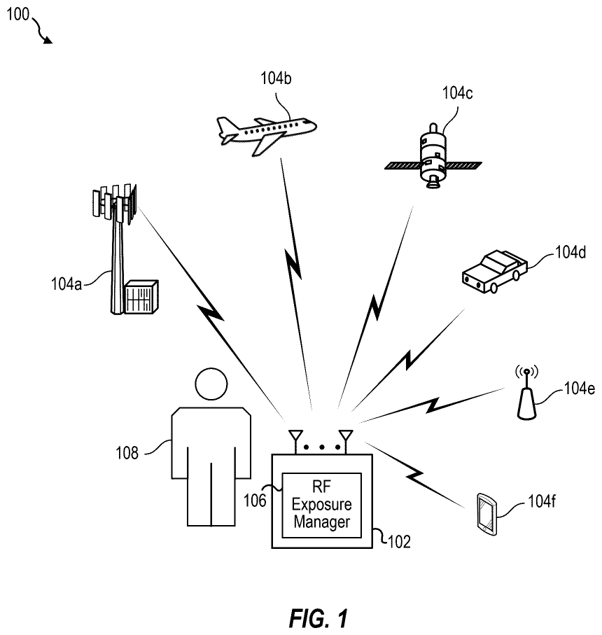

FIG. 1 illustrates an example wireless communication system 100 in which aspects of the present disclosure may be performed. For example, the wireless communication system 100 may include a wireless wide area network (WWAN) and/or a wireless local area network (WLAN). A WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof, as illustrative examples. A WLAN may include a wireless network configured for communications according to an IEEE standard such as one or more of the 802.11 standards, as illustrative examples. In some cases, the wireless communication system 100 may include a D2D communications network or a short-range communications system, such as Bluetooth communications.

As illustrated in FIG. 1, the wireless communication system 100 may include a wireless device 102 communicating with any of various wireless devices 104a-104f (a wireless device 104) via any of various RATs, where a wireless device may refer to a wireless communication device. The RATs may include, for example, WWAN communications (e.g., E-UTRA and/or 5G NR), WLAN communications (e.g., IEEE 802.11), V2X communications, NTN communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may be positioned proximate to the human 108 as a mobile hotspot. To ensure the human 108 is not overexposed to RF emissions from the wireless device 102, the wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station (STA), an access point (AP), a customer-premises equipment (CPE), etc. The wireless device 102 includes an RF exposure manager 106 that manages the RF exposure associated with one or more radios in compliance with an RF exposure limit. In certain aspects, the RF exposure manager 106 can reserve transmit power resources for the wireless device 102 to use for communications during an emergency session, in accordance with certain aspects of the present disclosure.

The wireless devices 104a-104f may include, for example, a base station 104a, an aircraft 104b, a satellite 104c, a vehicle 104d, an AP 104e, and/or a UE 104f. Further, the wireless communication system 100 may include terrestrial aspects, such as ground-based network entities (e.g., the base station 104a and/or AP 104e), and/or non-terrestrial aspects, such as the aircraft 104b and the satellite 104c, which may include network entities on-board (e.g., one or more base stations) capable of communicating with other network elements (e.g., terrestrial base stations) and/or UE(s).

The base station 104a may generally include: a NodeB (NB), enhanced NodeB (eNB), next generation enhanced NodeB (ng-eNB), next generation NodeB (gNB or gNodeB), AP, an AP STA, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a STA, a non-AP STA, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11(e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHz (e.g., 3G, 4G, 5G, 802.11a/b/g/n/ac, etc.) and using a second wireless communication technology operating above 6 GHz (e.g., mmWave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

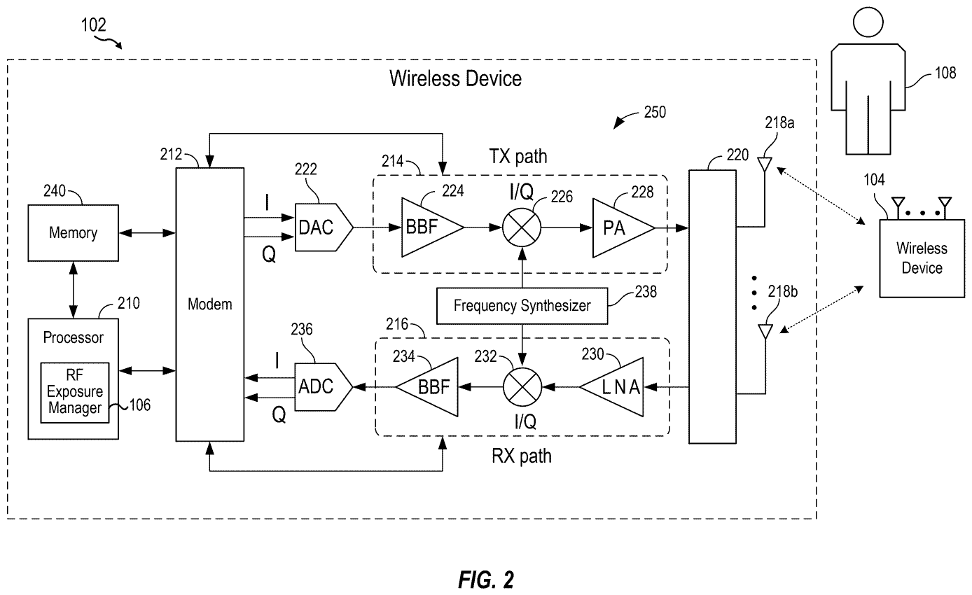

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

The processor 210 may implement the RF exposure manager 106. In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via the first antenna 218a, and a second signal may be transmitted via the second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

FIG. 2 shows one reference example of a transceiver design. It will be appreciated that other transceiver designs or architectures may be applied in connection with certain aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposure Compliance

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

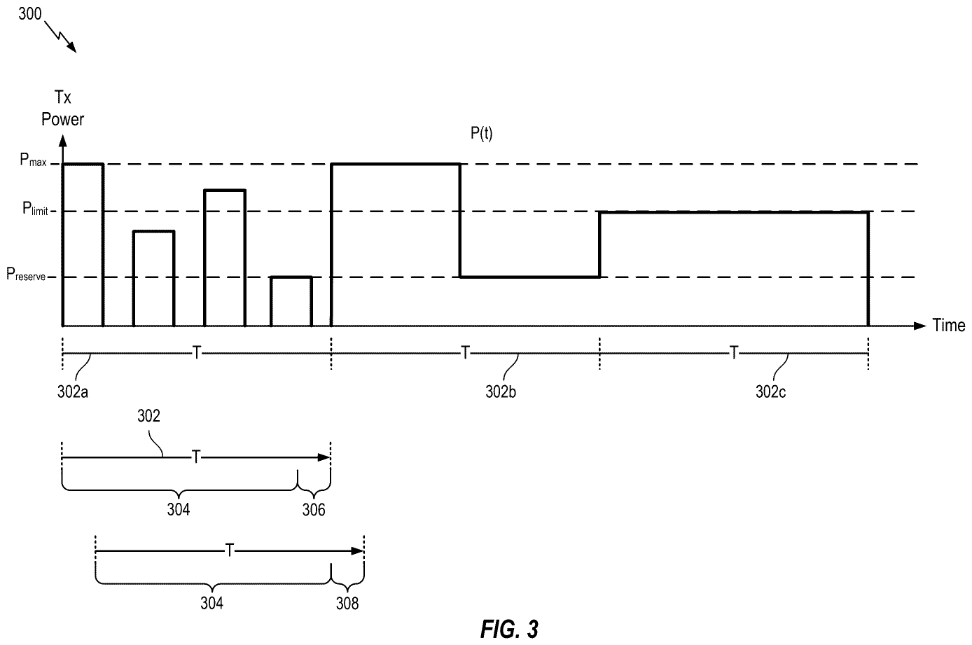

FIG. 3 is a graph 300 of a transmit power over time (P(t)) that varies over a running (e.g., rolling or moving) time window (T) associated with the RF exposure limit. The wireless device (e.g., the wireless device 102) may evaluate RF exposure compliance over the running time window 302 (T) based on past RF exposure (e.g., a transmit power report) in a past time interval 304 of the time window 302 and a future time interval 306. The wireless device may determine the maximum allowed transmit power for the future time interval 306 that satisfies the time-averaged RF exposure limit based on the past RF exposure used in the past time interval 304. The wireless device may perform such a time-averaging evaluation as the time window 302 moves over time, such as in the next future time interval 308, where the past time interval 304 now includes the previous future time interval 306 (e.g., the future time interval 306).

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the time window 302c such that the time-averaged transmit power over the time window (e.g., the time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the time window 302a and the time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the time window 302a.

In certain cases, a reserve power may be used to enable a continuous transmission within a time window (T) when transmitting above Pₗᵢₘᵢₜ in the time window or to enable a certain level of quality for certain transmissions. As shown in the time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 302 for certain transmissions (e.g., control signaling). Pᵣₑₛₑᵣᵥₑ may also be referred to as a “control power level” or “control level.”

In the time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than (or equal to) Pₘₐₓ in the time-average mode illustrated in the time window 302b. While a single transmit burst is illustrated in the time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power at or above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 milliseconds (ms)) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 302a, the duty cycle may be greater than 50% of the duration of the time window (T), whereas in the time window 302b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

In some cases, a controller (e.g., a WWAN modem) may control the RF exposure exhibited by WWAN radios in addition to other radios (e.g., WLAN radio(s) and/or Bluetooth radio(s)). For example, in some such configurations, the controller may implement the RF exposure manager 106.

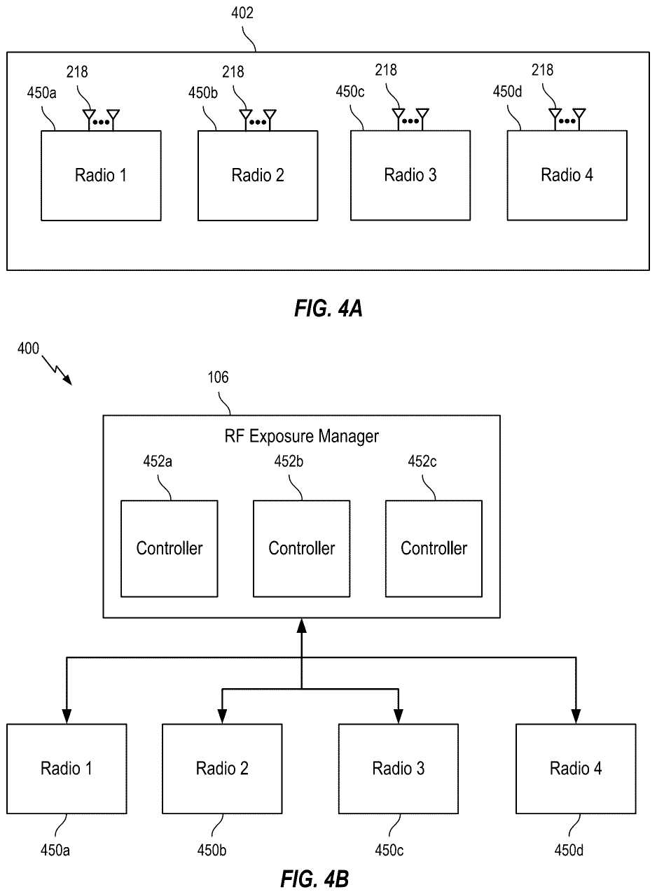

FIG. 4A is a diagram illustrating an example wireless device 402 (e.g., the wireless device 102) having multiple radios 450a-450d (collectively, “the radios 450”). The radios 450 may be similar to the radio(s) 250 of the wireless device 102 depicted in FIG. 2. In the example depicted in FIG. 4A, the radios 450a-450d may be associated with any of various RATs and/or frequency bands. For example, the radio 450a (or radio 1) may communicate via WWAN RAT(s) (e.g., E-UTRA and/or 5G NR) in sub-6 GHz frequency bands. The radio 450b (or radio 2) may communicate via WWAN RAT(s) (e.g., 5G NR) in mmWave frequency bands. The radio 450 c (or radio 3) may communicate via WLAN RAT(s) in sub-6 GHz (e.g., 2.4 GHz, 5 GHz, and/or 6 GHz) frequency bands. The radio 450d (or radio 4) may communicate via short-range communications (e.g., Bluetooth) in a 2.4 GHz frequency band. While this example shows a wireless device having four radios, a wireless device may have any number of radios for wireless communications, such as a radio per frequency band associated with WWAN and/or WLAN communications, a radio per RAT, or a radio capable of communicating via multiple RATs, as illustrative, non-limiting examples. Further, while the radios are illustrated as being separate, two or more of the radios may share components or circuitry. For example, portions of a signal path may be shared. The shared portion may include a shared or common mixer, filter, amplifier, and/or ADC or DAC, etc.

FIG. 4B is a diagram illustrating an example logical architecture 400 for controlling the transmit power (and hence, the RF exposure) associated with one or more radios (e.g., the radios 450a-450d) of a wireless device (e.g., the wireless device 404). The RF exposure manager 106 may operate as a primary controller for controlling the RF exposure associated with the radios 450a-450d. The primary controller may be a central controller for determining the maximum allowed transmit powers that can be used for a future time interval based on past transmit powers associated with all of the radios 450 a-450d. For example, the RF exposure manager 106 may periodically (e.g., every 500 ms) receive certain information from the radios 450a-450d, where the information may include, for example, a requested transmit power or exposure margin for a future time interval (e.g., the time interval 306, 308) and/or past transmit power history associated with a time interval (e.g., the past time interval 304) and/or averaging time window (e.g., the time window 302) or indication of whether a radio was on (active) or transmitting during the time interval and/or averaging time window. The RF exposure manager 106 may periodically (e.g., every 500 ms) provide each of the radios with an RF exposure margin or maximum allowed transmit power for a future time interval (e.g., the future time interval 306, 308).

The primary controller may include any of a number of controllers (e.g., the controller 452a, the controller 452b, and/or the controller 452c). The controller 452a may represent the WWAN modem, the controller 452b may represent the WLAN modem, and the controller 452c may represent the Bluetooth modem, for example. Thus, while the controllers 452 are illustrated separate from the radios 450, the controllers 452 and/or certain functionality thereof may be included within or integrated with respective radios 450. The controllers 452 are illustrated as being within the RF exposure manager 106, but one or more of the controllers 452 may be implemented external to the RF exposure manager 106. Further, while certain of the controllers 452 are described as being associated with or configured to implement functionality of a particular radio and/or RAT, one or more of the controllers 452 may be agnostic with respect to radios and/or RATs, and/or may be shared by multiple radios. For example, a controller 452 may be included in an applications processor.

In some cases, a controller may take control of its own power limit and operate in a standalone manner (or mode) in response to the primary controller being in a particular state (e.g., idle mode, inactive, sleep mode, low power state, etc.). For example, when the controller 452a switches to a sleep or idle mode (e.g., due to the wireless device switching to reduced power mode), the controller 452b may operate in a standalone mode controlling the RF exposure associated with the radio 450c, and in some cases, the controller 452c may operate in standalone mode controlling the RF exposure associated with the radio 450d.

The primary controller (e.g., the controller 452a) may provide the other controllers 452b, 452c with certain information. For example, the primary controller may indicate to the other controllers that the primary controller is going to a state where the primary controller can no longer operate as the primary controller (for a particular or indefinite time). Additionally, the primary controller may indicate to the other controllers a respective transmit power budget (e.g., RF exposure budget or RF exposure margin) that applies for the radio(s) and/or RAT(s) while the primary controller is unable to operate as the primary controller (e.g., for the particular or indefinite time). The transmit power budget may be allocated to each radio and/or RAT in a manner to ensure compliance with the RF exposure limit. In general, the cumulative target powers associated with the radio(s) and/or RAT(s) may satisfy the RF exposure limit. For example, the controller 452b (and/or radio(s) 450 associated therewith) may be allocated 60% of the RF exposure budget for a given time window, and the controller 452 c (and/or radio(s) 450 associated therewith) may be allocated 40% of the RF exposure budget for the time window.

The primary controller may instruct the other controllers to use specific RF exposure calculations—for example, an RF exposure compliance algorithm (e.g., time-averaging or a particular maximum transmit power) with a preset parameter (e.g., RF exposure budget or transmit power level)—to control each of the other controllers' own power limits in a standalone manner. The RF exposure compliance algorithm may be the same or different among the controllers. For example, the complexity of the algorithms or calculations may be considered when instructing the controllers. It may be unnecessary for certain controllers to evaluate the same number of and/or type of criteria, and/or the controllers may have varying capabilities.

### Overview of Emergency Preparedness Communication Services (EPCS) Operation

Within the United States, national security and emergency preparedness (NS/EP) service is deployed over cellular and wireline networks, allowing emergency personnel and public safety users the ability to communicate on telecommunications networks during times of congestion. Many other countries have similar services as well, including Blue Light Mobile service in Belgium, Mobile Crisis Communications service in the Czech Republic, Mobile Telecommunications Privileged Access Scheme in Great Britain, Disaster Priority Telephone in Japan, and Wireless Priority Service (WPS) in Australia and Canada, as illustrative examples. However, while many of the existing emergency deployment infrastructure includes wireless networks (e.g., Wi-Fi) as last mile access, such infrastructure lacks priority access support over wireless networks.

To address this, certain wireless communication systems (e.g., IEEE 802.11be) have introduced support for emergency preparedness communication services (EPCS), which provides preferred or prioritized channel access over public/private wireless networks (e.g., Wi-Fi networks) in emergencies, such as floods, earthquakes, fires, hurricanes, and terrorist attacks, as illustrative examples. With EPCS, for example, wireless devices can gain priority access to the wireless medium with prioritized channel access parameters (e.g., dedicated EDCA parameters) for transmission of emergency traffic (or data). Compared to channel access parameters used for transmission of non-emergency traffic (e.g., non-EPCS traffic), such prioritized channel access parameters may include a smaller CWmin, a smaller CWmax, a lower AIFSN, and a higher TXOP limit, as illustrative examples. EPCS can provide a seamless NS/EP service experience to users while maintaining the priority and QoS in wireless access networks for communication of emergency traffic.

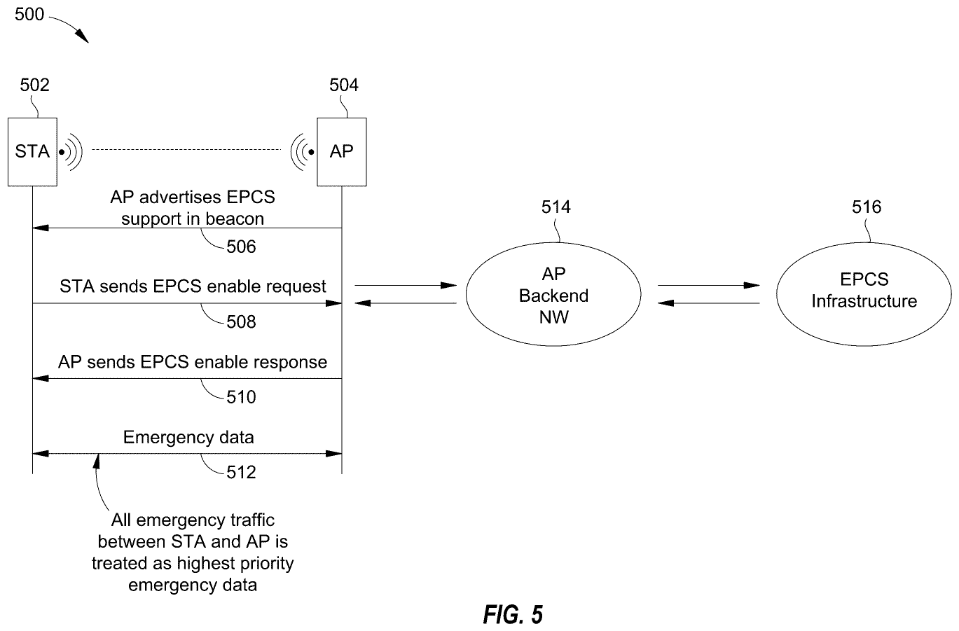

Consider FIG. 5, which depicts an example call flow 500 for establishing an EPCS session between a STA 502 and AP 504, according to certain aspects of the present disclosure. In the depicted example, STA 502 may be representative of a wireless device, such as wireless device 102 illustrated in FIGS. 1-2, and AP 504 may be representative of another wireless device, such as wireless device 104 illustrated in FIGS. 1-2. AP 504 may communicate with one or more APs via an AP backend network 514. The APs (including AP 504) may communicate with an EPCS infrastructure 516, which may include a network of systems and devices configured to communicate and coordinate the exchange of critical information during an emergency. As an illustrative example, EPCS infrastructure 516 may include a command center (e.g., a dedicated location where emergency response teams can monitor situations, coordinate actions, and disseminate information), public warning systems, satellite communication systems, and emergency management information systems (EMIS), as illustrative examples.

The depicted example assumes that AP 504 (e.g., an 802.11be AP) and STA 502 support EPCS. As illustrated in FIG. 5, at 506, the AP 504 transmits a beacon advertising (or indicating) EPCS support. The STA 502 may obtain the beacon and determine, from the beacon, that the AP 504 supports EPCS. Although not shown, the STA 502 may indicate EPCS support to the AP 504 in probe and (re)association requests. In some cases, the STA 502 and/or the AP 504 may advertise (or indicate) EPCS support prior to occurrence of an emergency (e.g., before the EPCS session is needed for use) or during the emergency.

When (or shortly after) an emergency occurs, the STA 502 may initiate (or invoke) establishment of an EPCS session by sending a management frame (e.g., action frame, such as an EPCS enable request) to the AP 504. As illustrated at 508 in FIG. 5, for example, the STA 502 sends an EPCS enable request to the AP to initiate establishment of an EPCS session. At 510, the AP 504 transmits an EPCS enable response to the STA 502 in response to the EPCS enable request. The EPCS enable response may indicate whether the EPCS session request is granted. At 512, assuming the EPCS enable response indicates the EPCS session request is granted, an EPCS session is established between the STA 502 and AP 504 for the exchange of emergency data. For a duration of the EPCS session, all emergency-related traffic (e.g., alerts, warnings, SOS (video) calls, etc.) between the STA 502 and AP 504 may be treated as highest priority emergency data.

In some cases, the STA 502 may operate according to EPCS parameters indicated by the AP 504 (e.g., in a beacon). Such EPCS parameters may include, for example, channel access parameters (e.g., CWmin, CWmax, AIFSN, TXOP limit, etc.), allowed/expected traffic types (e.g., traffic identifiers (TIDs)) for the EPCS session, or a combination thereof. In other cases, STA 502 may negotiate an EPCS session with desired EPCS parameters. After negotiation, the AP 504 may respond with an indication of the negotiated EPCS parameters in the EPCS enable response.

In some cases, the EPCS session may last for a duration of the emergency and/or until the priority treatment associated with the EPCS session is no longer needed (e.g., when congestion on the access network eases). Although not shown in FIG. 5, the STA 502 may initiate (or invoke) a termination of the EPCS session by sending another management frame (e.g., action frame, such as an EPCS teardown frame) to the AP 504. Additionally, although the scenario in FIG. 5 assumes that the STA 502 initiates establishment of the EPCS session (e.g., by sending an EPCS enable request) with the AP 504 and initiates termination of the EPCS session with the AP 504, in certain aspects, the AP 504 may initiate establishment of the EPCS session with the STA 502 and/or initiate termination of the EPCS session with the STA 502.

### Example Radio Frequency Exposure Compliance for EPCS Operation

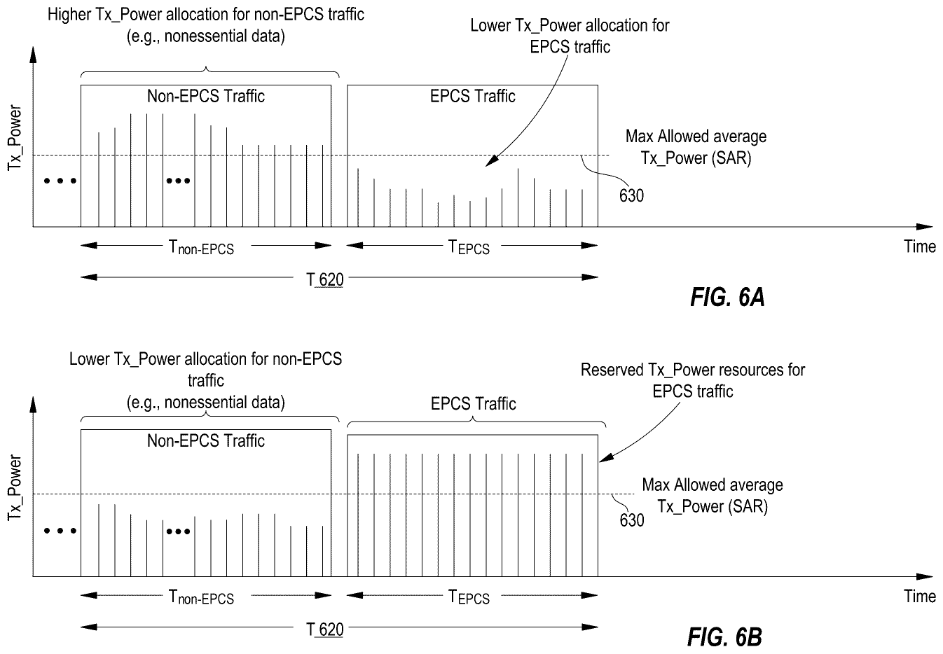

As noted above, in some cases, a wireless device may control the transmit power (and hence, the RF exposure) associated with one or more radios in a manner that impacts the communication performance of the wireless device. Consider the example scenario depicted in FIG. 6A, in which the wireless device allocates transmission power over a non-EPCS slot (or service periods) (e.g., T_{non-EPCS}) and an EPCS session (or slot or service period) (e.g., T_{EPCS}) during a time window (T) 620.

In the depicted scenario, during time window 620, the wireless device may allocate transmit power to radios in compliance with an RF exposure limit (e.g., time-averaged RF exposure limit) without protecting (or reserving) a set of transmit power resources for high-priority traffic (e.g., emergency traffic or data) during the EPCS session (e.g., T_{EPCS}) within the time window 620. As a result, in some scenarios, the wireless device may consume a large amount or portion of the transmit power budget (for the time window 620) during the non-EPCS slot (or service period) (e.g., T_{non-EPCS}) for communication of low-priority data (e.g., non-latency-sensitive traffic). As shown in FIG. 6A, for example, one or more transmissions over the non-EPCS slot may have an instantaneous transmission power that exceeds a maximum allowed average transmit power 630 for the time window 620.

Due to the high amount of transmit power consumed during the non-EPCS slot, the wireless device may allocate a lower amount of the transmit power budget during the EPCS session for communication of high-priority, latency-sensitive data (e.g. emergency traffic) in order to comply with the RF exposure limit (e.g., time-averaged RF exposure limit). As shown in FIG. 6A, for example, one or more transmissions over the EPCS session may have a transmission power that is less than the maximum allowed averaged transmit power 630 for the time window 620. In some cases, the low transmit power allocated to the EPCS session may impact the communication performance of the wireless device for communication of high-priority data in terms of lower throughput, lower transmit power, increased latency, high number of re-transmissions, and/or lower transmission range, as illustrative, non-limiting examples.

Aspects of the present disclosure provide apparatus and methods for optimizing (or at least improving) the communication performance of a wireless device during an emergency session (e.g., EPCS session) in compliance with an RF exposure limit. In certain aspects, the wireless device may reserve a certain amount of a transmit power budget (e.g., transmit power resources) for a wireless device to use during an emergency session. The transmit power budget may be applicable to a (running) time window that includes the emergency session or a portion thereof, and may be determined in compliance with an RF exposure limit (e.g., time-averaged RF exposure limit). The reservation of the amount of the transmit power budget for the emergency session may occur when (or shortly after) the emergency session has been established for the wireless device. The wireless device may perform communications during the emergency session based on the amount of the transmit power budget reserved for the emergency session.

In certain aspects, the wireless device may determine the amount of the transmit power budget to reserve for an emergency session, based on one or more parameters. Such parameter(s) may include a type of expected emergency communication (or traffic) to be exchanged during the emergency session, a highest sustainable transmit power parameter associated with a MCS rate used prior to the emergency session (e.g., R2P parameter), one or more weight parameters, a parameter provided by a manufacturer of the wireless device, or any combination thereof.

The apparatus and methods for optimizing (or at least improving) communication performance of the wireless device during an emergency session in compliance with an RF exposure limit may provide various advantages. For example, reserving a certain amount of transmit power resources for the emergency session using the techniques described herein may allow the wireless device to improve wireless communication performance (e.g., increased throughput, decreased latency, increased transmission range, and/or lower number of retransmissions of data) during the emergency session for transmission of emergency data (e.g., high-priority, latency-sensitive data).

For example, as shown in FIG. 6B, the wireless device may reserve a certain amount of the transmit power budget for each time window (T) 620 for the EPCS session (e.g., T_{EPCS}) within the respective time window (T) 620. Here, for example, the overall estimated time-averaged transmit power distribution is higher for the EPCS session (e.g., T_{EPCS}) than for the non-EPCS slot (or service period) (e.g., T_{non-EPCS}). In some cases, one or more transmissions during the EPCS session may have a transmit power that exceeds the maximum allowed averaged transmit power 630 for the time window 620, but may still be in compliance with an RF exposure limit over the time window 620, e.g., as shown in FIG. 6B.

### Example Operations

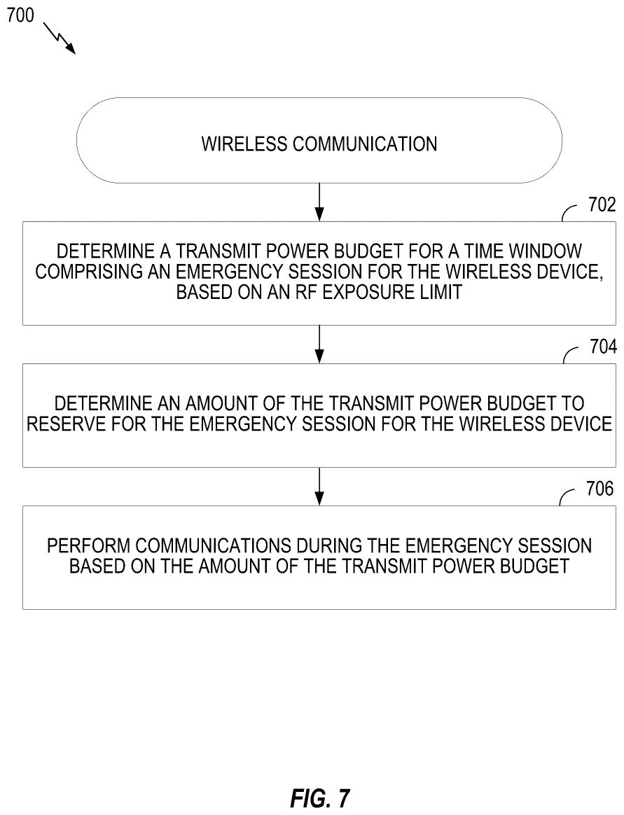

FIG. 7 is a flow diagram illustrating example operations 700 for wireless communication. The operations 700 may be performed, for example, by a wireless device (e.g., the wireless device 102 in the wireless communication system 100). The operations 700 may be implemented as software components that are executed and run on one or more processors (e.g., the processor 210 and/or the modem 212 of FIG. 2). For example, at least operations 702-704 may be performed by a controller (e.g., controller 452), such as in an RF exposure manager (e.g., RF exposure manager 106) and/or dedicated to a particular radio (e.g., a WLAN radio). Further, the transmission and/or reception of signals by the wireless device in the operations 700 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 700 may optionally begin, at block 702, where the wireless device may determine a transmit power budget for a time window (e.g., time window (T) 620) including an emergency session (e.g., EPCS session, such as T_{EPCS}) or portion thereof for the wireless device, based on an RF exposure limit. The RF exposure limit may be a time-averaged RF exposure limit.

At block 704, the wireless device may determine an amount of the transmit power budget to reserve for the emergency session for the wireless device. In certain aspects, the wireless device may determine the amount of the transmit power budget to reserve for the emergency session based on one or more parameters.

In certain aspects, the one or more parameters may include a highest sustainable transmit power parameter associated with a MCS rate used prior to the emergency session (e.g., R2P parameter). For example, the wireless device may consider the highest sustainable transmit power of the MCS rate used in the previous 500 ms or some other amount of time prior to the emergency session to avoid over-estimation of the transmit power reservation. In some examples, the reserved transmit power budget may be based on the highest sustainable transmit power being maintained for the entirety of the (duration of the) emergency session (or for the entirety of a portion of the emergency session if the session is not entirely within the time window), or based on being able to transmit at the highest sustainable transmit power during all times in the emergency session allowed by a duty cycle allocation.

In certain aspects, the one or more parameters may include one or more weight parameters associated with the amount of the transmit power budget. In some cases, the weight parameter(s) may be based on a type of expected communication (e.g., traffic type) for the emergency session. For example, a first weight parameter W₁ may be used to reserve a first amount of the transmit power budget for video data, a second weight parameter W₂ may be used to reserve a second amount of the transmit power budget for voice data (e.g., VoWiFi), a third weight parameter W₃ may be used to reserve a third amount of the transmit power budget for text data, and so on.

In certain aspects, the weight parameter(s) may be provided by a manufacturer of the wireless device. For example, the wireless device may obtain the weight parameter(s) provided by the manufacturer from a configuration file associated with the wireless device or from a register or exposure file structure with the manufacturer setting. The configuration file (e.g., initialization (INI) file format, bitmap distribution format (BDF) file format, etc.) may include an indication of the weight parameters, where each weight parameter indicates the amount of the transmit power budget that should be reserved for the emergency session. For example, the indication may be a percentage of the transmit power budget (e.g., 25% of the transmit power budget), a range of percentages of the transmit power budget (e.g., 25-50% of the transmit power budget), a transmit power level and a duration at the transmit power level, or any combination thereof. In some examples, the indication is 100%, such that the emergency session is allocated all power available to the radio. The weight parameter(s) may be a configurable value.

In certain aspects, the wireless device may adjust one or more of the weight parameter(s) based on one or more conditions. The condition(s) may include at least one of the type of the emergency communications, an expected amount of data associated with the type of the emergency communications, or the transmit power budget.

In some examples, it may not be possible to immediately reserve the amount of the transmit power budget determined based on the one or more parameters. For example, there may have been high power transmissions previously which will be included in a time window that also includes the emergency session. In some such examples, the reserve is set to the amount of remaining power for the time window. In other examples, the reserve is calculated based on a portion of the remaining power. In some examples, the reserve may be fully allocated in a next transmission slot or after an amount of time equal to a time window has passed.

In certain aspects, the weight parameter(s) includes a percentage or margin, and the amount of power reserved is determined by adding the margin to Pₗᵢₘᵢₜ or multiplying Pₗᵢₘᵢₜ by the margin and adding that result to Pₗᵢₘᵢₜ. In certain aspects, the weight parameter includes an indication from the AP to the STA including an amount of power to reserve and/or a modification of Pₗᵢₘᵢₜ, or a negotiated value between the AP and STA.

In certain aspects, determining the amount of the transmit power budget (at block 704) includes requesting at least a portion of the amount of the transmit power budget from a controller associated with one or more radios of the wireless device. For example, when an EPCS session has been established for the wireless device, a controller associated with a WLAN modem (e.g., controller 452b) may request a portion of the amount of the transmit power budget from a primary controller (e.g., controller 452a). In some cases, the requested portion may be different than a previous allocation of the transmit power budget for the emergency session. For example, if the controller associated with the WLAN modem determines that the previous allocation of the transmit power budget is insufficient for maintaining a target/desired communication performance for transmission of emergency communications during the emergency session, then the controller may request a larger portion of the transmit power budget from the primary controller. In some cases, the requested portion may include all of the transmit power budget. In other examples, the WLAN modem (e.g., controller 452b) may alert the primary controller (e.g., controller 452a) that an EPCS session has been negotiated, and the primary controller may determine at block 704 the amount of the transmit power budget to reserve. In yet other examples, the WLAN controller may operate without reference to another controller, for example when the WLAN controller is a standalone controller or is assigned a static amount of power to manage, and/or is itself the primary controller.

In certain aspects, the amount of the transmit power budget reserved for the emergency session may be greater than another amount of the transmit power budget allocated to a non-emergency session (e.g., non-EPCS slot, such as T_{non-EPCS}) allocated to the wireless device. In some cases, the amount of the transmit power budget reserved for the emergency session may be greater than another amount of the transmit power budget allocated to the non-emergency session, even when the duration of the non-emergency session is greater than the emergency session.

In certain aspects, the amount of the transmit power budget reserved for the emergency session may be greater than a maximum average transmit power level (e.g., transmit power 630) allowed for compliance with an RF exposure limit (e.g., time-averaged RF exposure limit) during the time window. For example, the overall estimated time-averaged transmit power distribution may be higher for communication traffic during the emergency session than for communication traffic during the non-emergency session. In some cases, Pₘₐₓ is reserved for a duration of the emergency session.

At block 706, the wireless device may perform communications during the emergency session based on the amount of the transmit power budget. For example, the wireless device may use the amount of the transmit power budget to transmit emergency communications, which may include high-priority, latency-sensitive traffic, such as alerts and warnings, directives about evacuation, curfews, and other self-protective actions, and information about response status and available assistance, as illustrative examples. The emergency communications may include any one of (or combination of) various data types, such as voice data (e.g., voice (SOS) calls over wireless networks, also known as VoWiFi), video data (e.g., streaming video content), file transfer data, and sensor data (e.g., data collected from wireless sensors in IoT applications), as illustrative examples.

In certain aspects, the operations 700 may further involve determining that the emergency session has been established for the wireless device, wherein the amount of the transmit power budget to reserve is determined after determining that the emergency session has been established for the wireless device. In such aspects, determining the amount of the transmit power budget to reserve includes determining that at least one transmit power restriction associated with the wireless device is disabled for a duration of the emergency session. Additionally or alternatively, in such aspects, determining that the emergency session has been established includes receiving, from an access point, a message indicating establishment of the emergency session.

In certain aspects, the operations 700 may further involve sending communications (e.g., non-EPCS traffic or data) during a non-emergency session (e.g., non-EPCS slot, such as T_{non-EPCS}) for the wireless device. In such aspects, the non-emergency session (e.g., non-EPCS slot) and the emergency session (e.g., EPCS slot) may occur during a same time window (e.g., time window (T) 620). As noted, in some such aspects, the amount of the transmit power budget allocated for transmission of communication traffic during the non-emergency session (e.g., T_{non-EPCS}) may be impacted by the amount of the transmit power budget reserved for the emergency session (e.g., T_{EPCS}). In certain examples, there may be a lower transmit power allocation for communication traffic during the non-emergency session, compared to the transmit power allocation for communication traffic during the emergency session. In certain examples, the communication traffic during the non-emergency session may be transmitted at a power reduced by an amount of the transmit power budget reserved for transmission of communication traffic during the non-emergency session.

As also noted, in certain cases where communication traffic (e.g., non-EPCS traffic) has been previously transmitted in a time window that also includes the emergency session, the amount of the transmit power budget that is reserved for the emergency session may be set to the amount of remaining power for the time window. In some such examples, the reserve is set to the amount of remaining power for the time window. In other examples, the reserve is calculated based on a portion of the remaining power. In some examples, the reserve may be fully allocated in a next transmission slot or after an amount of time equal to a time window has passed.

### Example Communications Device

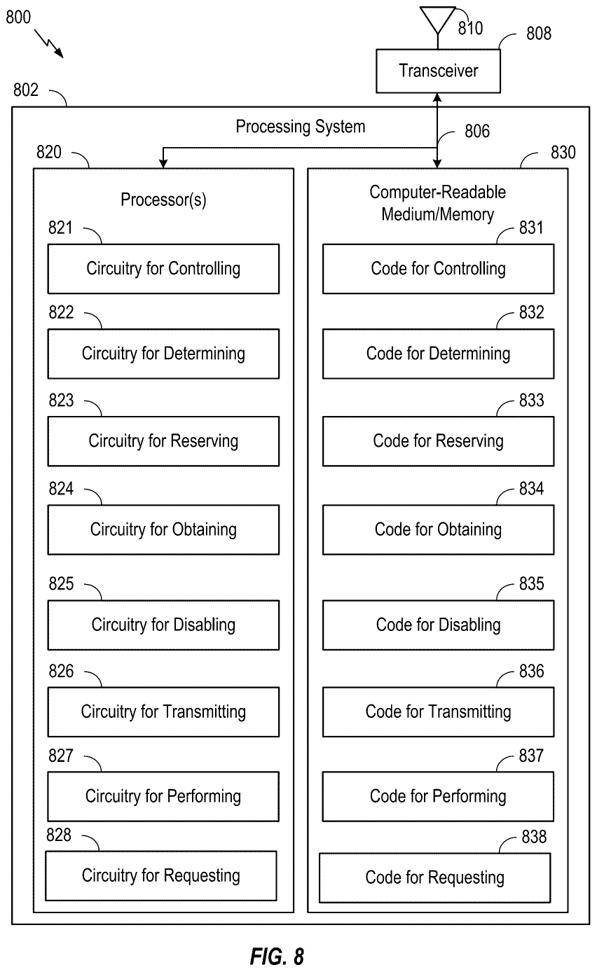

FIG. 8 depicts aspects of an example communications device 800. In some aspects, communications device 800 is a wireless communication device, such as the wireless device 102 described above with respect to FIGS. 1 and 2.

The communications device 800 includes a processing system 802 coupled to a transceiver 808 (e.g., a transmitter and/or a receiver). The transceiver 808 is configured to transmit and receive signals for the communications device 800 via an antenna 810, such as the various signals as described herein. The processing system 802 may be configured to perform processing functions for the communications device 800, including processing signals received and/or to be transmitted by the communications device 800.

The processing system 802 includes one or more processors 820. In various aspects, the one or more processors 820 may be representative of any of the processor 210 and/or the modem 212, as described with respect to FIG. 2. The one or more processors 820 are coupled to a computer-readable medium/memory 830 via a bus 806. In certain aspects, the computer-readable medium/memory 830 is configured to store instructions (e.g., computer-executable code) that when executed by the one or more processors 820, cause the one or more processors 820 to perform the operations 700 described with respect to FIG. 7 or any aspect related to the operations described herein. Note that reference to a processor performing a function of communications device 800 may include one or more processors performing that function of communications device 800.

In the depicted example, computer-readable medium/memory 830 stores code (e.g., executable instructions) for controlling 831 (including code for allocating and code for managing), code for determining 832, code for reserving 833, code for obtaining 834, code for disabling 835, code for transmitting 836, code for performing 837, code for requesting 838, and code for adjusting (not shown). Processing of the code 831-838 may cause the communications device 800 to perform the operations 700 described with respect to FIG. 7 or any aspect related to operations described herein.

The one or more processors 820 include circuitry configured to implement (e.g., execute) the code stored in the computer-readable medium/memory 830, including circuitry for controlling 821 (including circuitry for allocating and circuitry for managing), circuitry for determining 822, circuitry for reserving 823, circuitry for obtaining 824, circuitry for disabling 825, circuitry for transmitting 826, circuitry for performing 827, circuitry for requesting 828, and circuitry for adjusting (not shown). Processing with circuitry 821-828 may cause the communications device 800 to perform the operations 700 described with respect to FIG. 7 or any aspect related to operations described herein.

Various components of the communications device 800 may provide means for performing the operations 700 described with respect to FIG. 7 or any aspect related to operations described herein. For example, means for transmitting, sending or outputting for transmission may include the TX path 214 and/or antenna(s) 218 of the wireless device 102 illustrated in FIG. 2 and/or transceiver 808 and antenna 810 of the communications device 800 in FIG. 8. Means for receiving or obtaining may include the RX path 216 and/or antenna(s) 218 of the wireless device 102 illustrated in FIG. 2, and/or transceiver 808 and antenna 810 of the communications device 800 in FIG. 8. Means for controlling, means for performing, means for adjusting, means for disabling, means for requesting, means for operating, means for reserving, means for determining, means for detecting, means for obtaining, and/or means for providing may include a processor, such as the processor 210 and/or modem 212 depicted in FIG. 2 and/or the processor(s) 820 in FIG. 8.

### Example Aspects

Implementation examples are described in the following numbered clauses:

Clause 1: A method of wireless communication by a wireless device, comprising: determining a transmit power budget for a time window comprising an emergency session for the wireless device, based on a radio frequency (RF) exposure limit; determining an amount of the transmit power budget to reserve for the emergency session for the wireless device; and performing communications during the emergency session based on the amount of the transmit power budget.

Clause 2: The method of Clause 1, wherein the RF exposure limit is a time-averaged RF exposure limit.

Clause 3: The method in accordance with any of Clauses 1-2, wherein the amount of the transmit power budget is greater than a maximum average transmit power level allowed for compliance with the RF exposure limit during the time window.

Clause 4: The method in accordance with any of Clauses 1-3, wherein the amount of the transmit power budget is determined based on a highest sustainable transmit power parameter associated with a modulation and coding scheme (MCS) rate used prior to the emergency session.

Clause 5: The method in accordance with any of Clauses 1-4, further comprising determining that the emergency session has been established for the wireless device, wherein the amount of the transmit power budget to reserve is determined after determining that the emergency session has been established for the wireless device.

Clause 6: The method of Clause 5, wherein determining the amount of the transmit power budget to reserve comprises determining that at least one transmit power restriction associated with the wireless device is disabled for a duration of the emergency session.

Clause 7: The method in accordance with any of Clauses 5-6, wherein determining that the emergency session has been established comprises receiving, from an access point, a message indicating establishment of the emergency session.

Clause 8: The method in accordance with any of Clauses 1-7, wherein the amount of the transmit power budget is determined based on one or more weight parameters associated with the amount of the transmit power budget.

Clause 9: The method of Clause 8, wherein: performing the communications comprises sending or receiving emergency communications; and the one or more weight parameters are based on a type of the emergency communications.

Clause 10: The method of Clause 9, wherein determining the amount of the transmit power budget comprises adjusting the one or more weight parameters based on one or more conditions.

Clause 11: The method of Clause 10, wherein the one or more conditions comprise at least one of the type of the emergency communications, an expected amount of data associated with the type of the emergency communications, or the transmit power budget.

Clause 12: The method in accordance with any of Clauses 9-11, wherein the one or more weight parameters are provided by a manufacturer of the wireless device.

Clause 13: The method of Clause 12, further comprising obtaining the one or more weight parameters provided by the manufacturer from a configuration file associated with the wireless device.

Clause 14: The method in accordance with any of Clauses 1-13, further comprising transmitting communications during a non-emergency session for the wireless device, the non-emergency session and the emergency session occurring in a same time window.

Clause 15: The method of Clause 14, wherein the amount of the transmit power budget is greater than another amount of the transmit power budget allocated to the non-emergency session for the wireless device.

Clause 16: The method in accordance with any of Clauses 1-15, wherein determining the amount of the transmit power budget comprises requesting at least a portion of the amount of the transmit power budget from a controller associated with one or more radios of the wireless device.

Clause 17: The method in accordance with any of Clauses 1-16, wherein the amount of the transmit power budget comprises a transmit power level and a duration at the transmit power level.

Clause 18: The method in accordance with any of Clauses 1-17, wherein the emergency session comprises an emergency preparedness communication services (EPCS) session pursuant to an Institute of Electrical and Electronics Engineers standard.

Clause 19: An apparatus comprising: one or more memories collectively storing executable instructions; and one or more processors coupled to the one or more memories, the one or more processors being collectively configured to execute the executable instructions and cause the apparatus to perform a method in accordance with any of Clauses 1-18.

Clause 20: An apparatus for wireless communications, comprising means for performing a method in accordance with any of Clauses 1-18.

Clause 21: A non-transitory computer-readable medium comprising computer-executable instructions that, when executed by one or more processors of a processing system, cause the processing system to perform a method in accordance with any of Clauses 1-18.

Clause 22: A computer program product embodied on a computer-readable storage medium comprising code for performing a method in accordance with any of Clauses 1-18.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIG. 7).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
determining a transmit power budget for a time window comprising an emergency session for the wireless device, based on a radio frequency (RF) exposure limit;
determining an amount of the transmit power budget to reserve for the emergency session for the wireless device; and
performing communications during the emergency session based on the amount of the transmit power budget.

2. The method of claim 1, wherein the RF exposure limit is a time-averaged RF exposure limit.

3. The method of claim 1, wherein the amount of the transmit power budget is greater than a maximum average transmit power level allowed for compliance with the RF exposure limit during the time window.

4. The method of claim 1, wherein the amount of the transmit power budget is determined based on a highest sustainable transmit power parameter associated with a modulation and coding scheme (MCS) rate used prior to the emergency session.

5. The method of claim 1, further comprising determining that the emergency session has been established for the wireless device, wherein the amount of the transmit power budget to reserve is determined after determining that the emergency session has been established for the wireless device.

6. The method of claim 5, wherein determining the amount of the transmit power budget to reserve comprises determining that at least one transmit power restriction associated with the wireless device is disabled for a duration of the emergency session.

7. The method of claim 5, wherein determining that the emergency session has been established comprises receiving, from an access point, a message indicating establishment of the emergency session.

8. The method of claim 1, wherein the amount of the transmit power budget is determined based on one or more weight parameters associated with the amount of the transmit power budget.

9. The method of claim 8, wherein:
performing the communications comprises sending or receiving emergency communications; and
the one or more weight parameters are based on a type of the emergency communications.

10. The method of claim 9, wherein determining the amount of the transmit power budget comprises adjusting the one or more weight parameters based on one or more conditions.

11. The method of claim 10, wherein the one or more conditions comprise at least one of the type of the emergency communications, an expected amount of data associated with the type of the emergency communications, or the transmit power budget.

12. The method of claim 9, wherein the one or more weight parameters are provided by a manufacturer of the wireless device.

13. The method of claim 12, further comprising obtaining the one or more weight parameters provided by the manufacturer from a configuration file associated with the wireless device.

14. The method of claim 1, further comprising transmitting communications during a non-emergency session for the wireless device, the non-emergency session and the emergency session occurring in a same time window.

15. The method of claim 14, wherein the amount of the transmit power budget is greater than another amount of the transmit power budget allocated to the non-emergency session for the wireless device.

16. The method of claim 1, wherein determining the amount of the transmit power budget comprises requesting at least a portion of the amount of the transmit power budget from a controller associated with one or more radios of the wireless device.

17. The method of claim 1, wherein the amount of the transmit power budget comprises a transmit power level and a duration at the transmit power level.

18. The method of claim 1, wherein the emergency session comprises an emergency preparedness communication services (EPCS) session pursuant to an Institute of Electrical and Electronics Engineers standard.

19. An apparatus for wireless communication, comprising:
one or more memories collectively storing executable instructions; and
one or more processors coupled to the one or more memories, the one or more processors being collectively configured to execute the executable instructions to cause the apparatus to:
determine a transmit power budget for a time window comprising an emergency session for the apparatus, based on a radio frequency (RF) exposure limit;
determine an amount of the transmit power budget to reserve for the emergency session for the apparatus; and
perform communications during the emergency session based on the amount of the transmit power budget.

20. An apparatus for wireless communications, comprising:
means for determining a transmit power budget for a time window comprising an emergency session for the apparatus, based on a radio frequency (RF) exposure limit;
means for determining an amount of the transmit power budget to reserve for the emergency session for the apparatus; and
means for performing communications during the emergency session based on the amount of the transmit power budget.
